(19) United States
(12) Patent Application Publication
(10) Pub. No.: US 2024/0005945 A1
(43) Pub. Date: Jan. 4, 2024

(54) DISCRIMINATING BETWEEN DIRECT AND MACHINE GENERATED HUMAN VOICES

(71) Applicant: AONDEVICES, INC., Irvine, CA (US)

(72) Inventors: Mouna Elkhatib, Irvine, CA (US); Adil Benyassine, Irvine, CA (US); Aruna Vittal, Irvine, CA (US); Eli Uc, Irvine, CA (US); Ziad Mansour, Irvine, CA (US)

(21) Appl. No.: 18/344,765

(22) Filed: Jun. 29, 2023

Related U.S. Application Data
(60) Provisional application No. 63/356,546, filed on Jun. 29, 2022.

(51) Int. Cl. G10L 25/69; G10L 25/30

(52) U.S. Cl. CPC G10L 25/69; G10L 25/30

(57) ABSTRACT

Discriminating between direct and machine-generated human voices is disclosed. A directly-generated voice audio sample from a human utterance and a machine-generated voice audio sample outputted by a loudspeaker from a pre-recording of another human utterance are captured on a microphone. Discriminative features between the directly-generated voice audio sample and the machine-generated voice audio sample are extracted with a machine learning classifier. A response to a command in the captured directly-generated voice audio sample or the captured machine-generated voice audio sample may be selectively generated.

### CROSS-REFERENCE TO RELATED APPLICATIONS

This application relates to and claims the benefit of U.S. Provisional Application No. 63/356,546 filed Jun. 29, 2022, and entitled “METHOD FOR DISCRIMINATING BETWEEN DIRECT AND MACHINE GENERATED HUMAN VOICES,” the entire disclosure of which is wholly incorporated by reference herein.

### STATEMENT RE: FEDERALLY SPONSORED RESEARCH/DEVELOPMENT

Not Applicable

### BACKGROUND

### 1. Technical Field

The present disclosure relates generally to human-computer interfaces and machine learning, and more particularly to discriminating between direct and machine-generated human voices.

### 2. Related Art

Virtual assistant systems are incorporated into a wide variety of consumer electronics devices, including smartphones/tablets, personal computers, wearable devices, smart speaker devices such as Amazon Echo, Apple HomePod, and Google Home, as well as household appliances and motor vehicle entertainment systems. In general, virtual assistants enable natural language interaction with computing devices regardless of the input modality, though most conventional implementations incorporate voice recognition and enable hands-free interaction with the device. Examples of possible functions that may be invoked via a virtual assistant include playing music, activating lights or other electrical devices, answering basic factual questions, and ordering products from an e-commerce site. Beyond virtual assistants incorporated into smartphones and smart speakers, there are a wide range of autonomous devices that capture various environmental inputs and responsively performing an action, and numerous household appliances such as refrigerators, washing machines, driers, ovens, timed cookers, thermostats/climate control devices, and the like now incorporate voice-controlled interfaces.

There have been reported incidents in which virtual assistant devices respond to commands not directly issued by the user, such as television advertisements, announcements, and dialogue in movies, shows, and other content. Some have occurred during large broadcast sporting events watched by a sizeable audience.

Some possible solutions that have been published include acoustic-fingerprinting algorithms like those disclosed by Haitsma and Kalker, “A Highly Robust Audio Fingerprinting System.” These algorithms are designed to be robust to audio distortion and interference, such as those introduced by television speakers, the home environment, and our microphones. This type of solution is only possible when the device already has audio samples of the broadcast content in advance, such as when a major advertiser and manufacturer of a personal assistant device has the data for the advertisement prior to broadcasting.

These methods also cannot be used in cases where there is an unintended trigger of the wake word. For example, in the case of malicious actors attempting to control a home, if a voice message left on an answering machine asking the personal assistant to perform certain tasks such as opening the door or ordering products, there is no access to the source for fingerprint or watermarking. The attackers may gain full access to the home once a single phone speaker or television speaker is accessed.

Accordingly, there is a need in the art for an improved system for discriminating between direct and machine-generated human voices.

### BRIEF SUMMARY

The embodiments of the present disclosure contemplate the discriminating of direct and machine-generated human voices. One possible application is the prevention of smart speakers incorporating virtual assistants from responding to audio inputs from sources other than humans, such as television content/advertisement dialog or malicious actors attempting to control the smart speakers. As virtual assistant-enabled devices become more ubiquitous, this functionality is envisioned to improve the coexistence of humans and smart devices within shared spaces.

An embodiment of the disclosure is a method for discriminating between direct and machine-generated human voices. The method may include capturing a directly-generated voice audio sample from a human utterance on a microphone, as well as capturing a machine-generated voice audio sample from a pre-recording of another human utterance on the microphone. There may also be a step of extracting, with a machine learning classifier, discriminative features between the directly-generated voice audio sample and the machine-generated voice audio sample. The method may also include selectively generating a response to a command in the captured directly-generated voice audio sample or the captured machine-generated voice audio sample.

Another embodiment of the disclosure may be a system for discriminating between direct and machine-generated human voices. The system may include a microphone capturing both directly-generated voice audio samples from a human utterance and a machine-generated voice audio samples outputted by a loudspeaker from a pre-recording of the human utterance. The system may also include a machine learning classifier receptive to the directly-generated voice audio samples and the machine-generated voice audio samples. The machine learning classifier may derive discriminative features between the directly-generated voice audio samples and the machine-generated voice audio samples and classifying as either directly generated or machine generated. An embodiment of the system may further include a command processor connected to the machine learning classifier. The command processor may selectively generate responses to commands in the input audio samples depending upon an activated one of operating modes.

The present disclosure may also include a non-transitory computer readable medium with instructions executable by a data processing device to perform the method for discriminating between direct and machine-generated human voices. The present disclosure will be best understood accompanying by reference to the following detailed description when read in conjunction with the drawings.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a block diagram illustrating the operation of a virtual assistant-enabled device;

FIG. 2 is a block diagram illustrating one embodiment of a system for discriminating between direct and machine-generated human voices;

FIG. 3 is a block diagram of an exemplary virtual assistant-enabled device in which the embodiments of the systems and methods for discriminating between direct and machine-generated human voices may be implemented;

FIG. 4 is a block diagram of one embodiment of the system for discriminating between direct and machine-generated human voices;

FIG. 5 is a flowchart showing a first operating mode or direct human voice action;

FIG. 6 is a flowchart showing a second operating mode or machine generated human voice action; and

FIG. 7 is a flowchart showing a third operating mode or machine generated or direct human voice action.

### DETAILED DESCRIPTION

The detailed description set forth below in connection with the appended drawings is intended as a description of the several presently contemplated embodiments of systems and methods for discriminating between direct and machine-generated human voices. It is not intended to represent the only form in which such embodiments may be developed or utilized, and the description sets forth the functions and features in connection with the illustrated embodiments. It is to be understood, however, that the same or equivalent functions may be accomplished by different embodiments that are also intended to be encompassed within the scope of the present disclosure. It is further understood that the use of relational terms such as first and second and the like are used solely to distinguish one from another entity without necessarily requiring or implying any actual such relationship or order between such entities.

Referring now to the diagram of FIG. 1, the embodiments of the present disclosure may be implemented in the context of a virtual assistant-enabled device 10 such as a smart speaker, a smart television set, a smart refrigerator, a smart watch, and so forth that is responsive to commands issued to it by voice input. The virtual assistant-enabled device 10 may be awoken from a sleep state with a wake word/phrase such as “hey Alexa,” “hey Google,” or “hey Siri,” depending on the specific virtual assistant(s) implemented thereon. The user may accompany the wake word with a request or query that may take a variety of forms, such as request for information, e.g., “what is the weather today?” completion of a task, e.g., “order laundry detergent,” “play music,” or “call my child,” and so on. In most implementations, the virtual assistant-enabled device 10 generates an audio response after completing the issued command, as well as provide any requested information.

The virtual assistant-enabled device 10 thus responds to voice inputs, regardless of whether it was made by a human user, or by proxy through some other device. The diagram of FIG. 1 illustrates such a case, where another device such as a television set 12 outputs an audio segment 14 with the wake word together with a command recognized by the virtual assistant-enabled device 10. In the example, there may be dialog in a scene calling for a character to order a product using a virtual assistant-enabled device, such as “hey Alexa, order laundry detergent.” This wake word and command sequence may be captured and processed by the real-world virtual assistant-enabled device 10, and inadvertently cause the laundry detergent to be ordered from a designated e-commerce site. While this example be at worst an innocent mistake, this vulnerability may be used for more nefarious purposes such as unlocking security systems or to remotely harass.

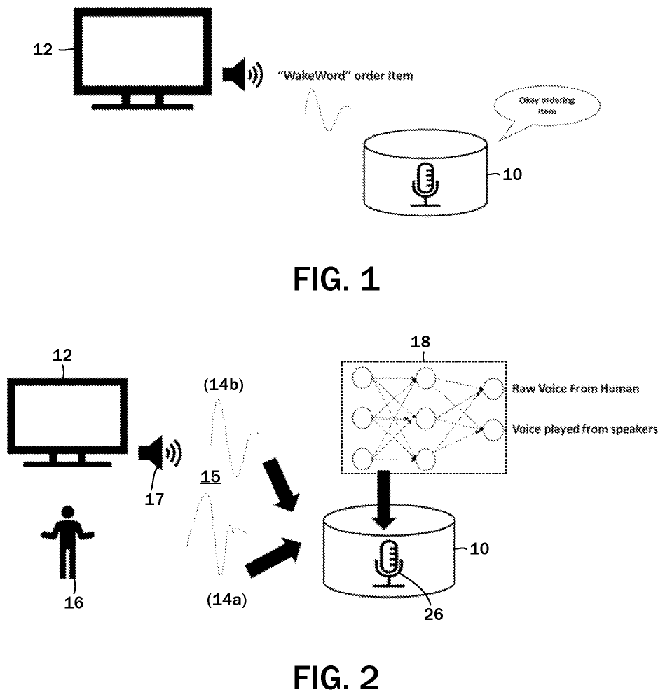

The block diagram of FIG. 2 illustrates an embodiment of the virtual assistant-enabled device 10 that may discern between the audio 14a generated from the human being 16 and the audio 14b generated from the television set 12. As will be described in further detail, a machine learning system 18 may be able to flag when the audio 14 originates from a sound transducing device, e.g., a loudspeaker in the television set 12, or from the human being 16. Depending on the results of its analysis, the virtual assistant-enabled device 10 may or may not respond to the command contained in the audio 14.

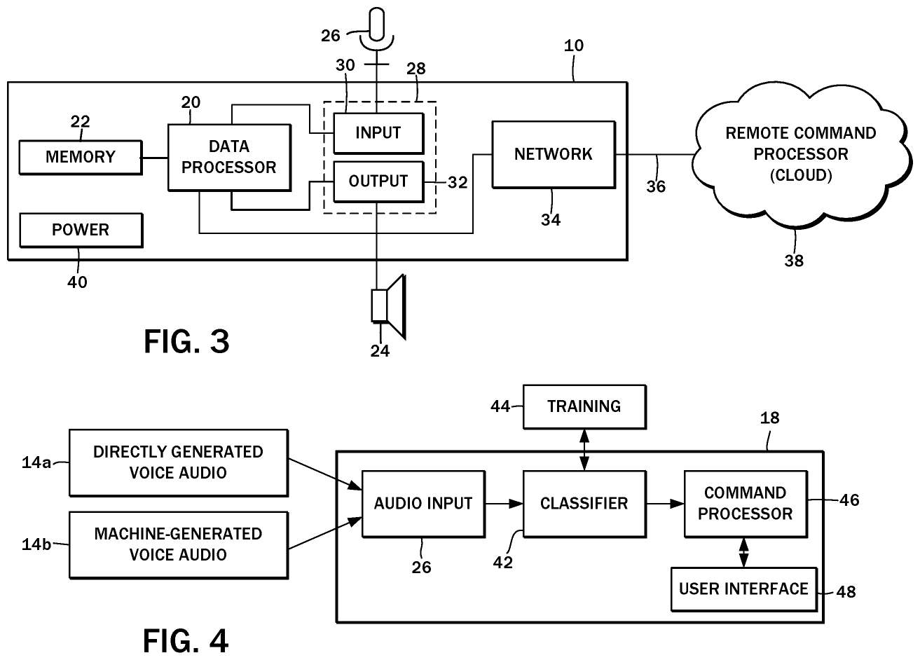

With reference to the block diagram of FIG. 3, a system for discriminating between direct and machine-generated human voices may be implemented on the virtual assistant-enabled device 10. In further detail, such device includes a data processor 20 that executes pre-programmed software instructions that correspond to various functional features of the virtual assistant-enabled device 10. These software instructions, as well as other data that may be referenced or otherwise utilized during the execution of such software instructions, may be stored in a memory 22. As referenced herein, the memory 22 is understood to encompass random access memory as well as more permanent forms of memory.

As the exemplary embodiment of the virtual assistant-enabled device 10 is a smart speaker, it is understood to incorporate a loudspeaker/audio output transducer 24 that outputs sound from corresponding electrical signals applied thereto. Furthermore, in order to accept audio input, the virtual assistant-enabled device 10 includes a microphone/audio input transducer 26. The microphone 26 is understood to capture sound waves and transduces the same to an electrical signal. According to various embodiments of the present disclosure, the virtual assistant-enabled device 10 may have a single microphone. However, it will be recognized by those having ordinary skill in the art that there may be alternative configurations in which the virtual assistant-enabled device 10 includes two or more microphones.

Both the loudspeaker 24 and the microphone 26 may be connected to an audio interface 28, which is understood to include at least an input analog-to-digital converter (ADC) 30 and an output digital-to-analog converter (DAC) 32. The input ADC 30 is used to convert the electrical signal transduced from the input audio waves to discrete-time sampling values corresponding to instantaneous voltages of the electrical signal. This digital data stream may be processed by the main processor, or a dedicated digital audio processor. The output DAC 32, on the other hand, converts the digital stream corresponding to the output audio to an analog electrical signal, which in turn is applied to the loudspeaker 24 to be transduced to sound waves. There may be additional amplifiers and other electrical circuits that within the audio interface 28, but for the sake of brevity, the details thereof are omitted. Furthermore, although the example virtual assistant-enabled device 10 shows a unitary audio interface 28, the grouping of the input ADC 30 and the output DAC 32 and other electrical circuits is by way of example and convenience only, and not of limitation.

In between the audio interface 28 and the data processor 20, there may be a general input/output interface that manages the lower-level functionality audio interface 28 without burdening the data processor 20 with such details. Although there may be some variations in the way the audio data streams to and from the audio interface 28 are handled thereby, the input/output interface abstracts any such variations. Depending on the implementation of the data processor 20, there may or may not be an intermediary input/output interface.

The virtual assistant-enabled device 10 may also include a network interface 34, which serves as a connection point to a data communications network 36. This data communications network 36 may be a local area network, the Internet, or any other network that enables a communications link between the virtual assistant-enabled device 10 and a remote note. In this regard, the network interface 34 is understood to encompass the physical, data link, and other network interconnect layers. As will be recognized by those having ordinary skill in the art, most of the processing of the voice command inputs is performed remotely on a cloud-based distributed computing platform 38. Although a limited degree of audio processing takes place at the virtual assistant-enabled device 10, the recorded audio data is transmitted to the distributed computing platform 38, and the network interface 34 and the data communications network 36 is the modality by which such data is communicated thereto.

As the virtual assistant-enabled device 10 is electronic, electrical power must be provided thereto in order to enable the entire range of its functionality. In this regard, the virtual assistant-enabled device 10 includes a power module 40, which is understood to encompass the physical interfaces to line power, an onboard battery, charging circuits for the battery, AC/DC converters, regulator circuits, and the like. Those having ordinary skill in the art will recognize that implementations of the power module 40 may span a wide range of configurations, and the details thereof will be omitted for the sake of brevity.

The data processor 20 is understood to control, receive inputs from, and/or generate outputs to the peripheral devices as described above. The grouping and segregation of the peripheral interfaces to the data processor 20 are presented by way of example only, as one or more of these components may be integrated into a unitary integrated circuit. Furthermore, there may be other dedicated data processing elements that are optimized for machine learning/artificial intelligence applications. One such integrated circuit is the AONDevices high-performance, ultra-low power edge AI device, AON1100 pattern recognition chip/integrated circuit. However, it will be appreciated by those having ordinary skill in the art that the embodiments of the present disclosure may be implemented with any other data processing device or integrated circuit utilized in the virtual assistant-enabled device 10. Although a basic enumeration of peripheral devices such as the loudspeaker 24 and the microphone 26 has been presented above, the virtual assistant-enabled device 10 need not be limited thereto. There may be other, additional peripheral devices incorporated into the virtual assistant-enabled devices 10 such as touch display screens, buttons, switches, and the like.

Additionally referring to FIG. 2, the virtual assistant-enabled device 10, and specifically the microphone 26 thereof, is understood to capture audio 14 from its environment 15. One source of the audio 14 may be the human being 16, while another may be a machine-generated source such as the television set 12. As depicted in the block diagram of FIG. 4, this audio from the human being 16 may also be referred to as the directly generated voice audio 14a, and the audio from the television set 12 may be referred to as the machine-generated voice audio 14b.

In most circumstances the machine-generated voice audio 14b is ultimately a human voice. However, prior to being transduced by the microphone 26, the audio is generated from a loudspeaker 17 on a different device (e.g., the television set 12), hence referred to as “machine-generated.” However, the audio 14b may also encompass synthesized or artificial voices. By itself, the microphone 26, or the virtual assistant-enabled device 10 without additional processing, is unable to discern the difference between the directly generated voice audio 14a and the machine-generated voice audio 14b. The embodiments of the present disclosure contemplate the virtual assistant-enabled device 10 discriminating between the audio sources and identifying when the audio 14 originates from the human being 16 or from an artificial source such as the loudspeaker 17. Assuming the path of the audio 14 through the environment 15 to the microphone 26 is the same in both cases, a machine learning classifier 42 finds or derives discriminative features in the different types of the audio 14.

The data processor 20 may be specially configured for machine learning/feature extraction/classification functions. Accordingly, the data processor 20 may also be referred to as the classifier 42. The specific machine learning modality that is implemented may be varied, including multilayer perceptron s, convolutional neural networks (CNNs), recurrent neural networks (RNNs) and so on that perform pattern recognition functions. Certain features of the audio 14 may be used to train the classifier 42 to discriminate between voice from the human 16 versus the voice from the machine/loudspeaker 17. The training may be performed on two classes: one of speech captured directly from a human source and another of speech captured from loudspeakers 17. It is possible to pair the classifier 42 with wake word detection modalities. Alternatively, the classifier 42 may operate as a standalone process. Further enhancements to the training may involve introducing various types of noise to guide the machine learning classifier 42 to learn the discriminative features even in noisy or otherwise harsh environments.

Although loudspeakers ideally reproduce sound efficiently without artifacts, this is not possible as a practical matter due to various design constraints that impact sound quality. These limitations are understood to impart distortions to the output audio, and can be used as discriminative features to determine its origin. For instance, the loudspeaker 17 may exhibit a non-flat frequency response in the audible frequency band, e.g., between 20 Hz to 20 kHz. There may also be ringing or vibration in the audio 14, or other distortions and noise. The foregoing enumeration of discriminative features is not intended to be exhaustive, as others may be found in the audio 14. In order to achieve the broadest coverage of different types discriminative features that may be present in the machine-generated voice audio 14, the classifier 42 may collect data from different speakers within the environment 15 such as home stereo system speakers, sound bars, intercom speakers, other smart speakers, and the like. Because of the design and manufacturing differences across multiple loudspeakers, target per deployment may be utilized for better discrimination.

These discriminative features are understood to be the basis for training the machine learning system of the classifier 42, and a training module 44 may be utilized for such purpose. A comprehensive training dataset is provided to the training module 44, and includes speech captured directly from humans as well as speech captured from loudspeakers 17. The training process may involve exposing the system to various types of noises to ensure its ability to discriminate between human and machine-generated voices in different environmental conditions.

As indicated above, the classifier 42 captures the directly generated voice audio 14a and/or the machine-generated voice audio 14 via the audio input or microphone 26, and the classifier 42 makes a determination as to whether it is one or the other. The determination may be passed to a command processor 46, where depending on the user-defined configuration, different processes may follow.

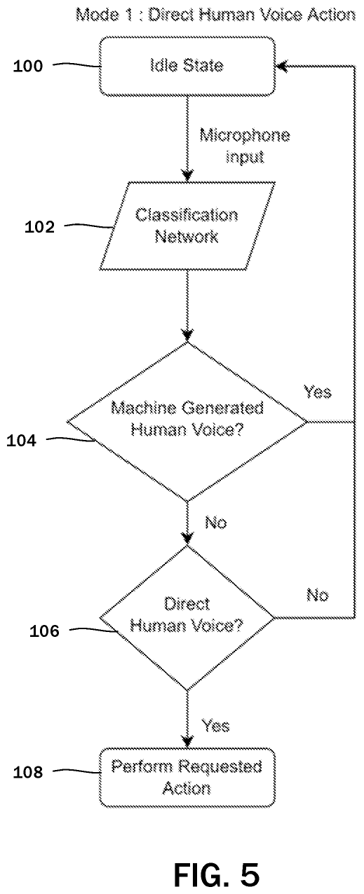

The flowchart of FIG. 5 illustrates a first mode of operation, referred to as direct human voice action. The virtual assistant-enabled device 10 initially begins in an idle state 100, and when the microphone 26 receives an input audio 14, the process moves to the classifier 42 in a step 102. If, per decision block 104 it is determined that the audio 14 is machine-generated, no further action takes place and the process returns to the idle state 100. In a decision block 106, the audio 14 is further analyzed whether it is a direct human voice. If in this secondary evaluation it is determined that the audio 14 is not a direct human voice, the process returns to the idle state 100. Upon affirmatively confirming that the audio is a direct human voice, the process moves to step 108 where commands/queries in the audio 14 are executed.

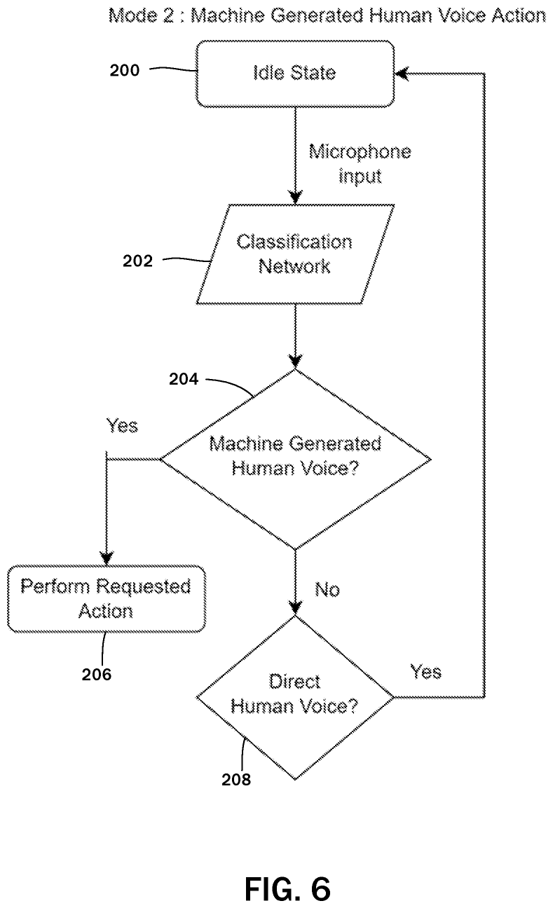

The flowchart of FIG. 6 illustrates a second mode of operation, referred to as machine generated human voice action. Again, the virtual assistant-enabled device 10 initially begins in an idle state 200, and when the microphone 26 receives an input audio 14, the process moves to the classifier 42 in a step 202. If, per decision block 204 it is determined that the audio 14 is machine-generated, the process moves to a step 206 of performing the requested action, that is, the commands/queries specified in the audio 14 are executed. Otherwise, the process moves to a decision block 208 of determining whether the audio 14 is a direct human voice. If so, the process returns to the idle state 200.

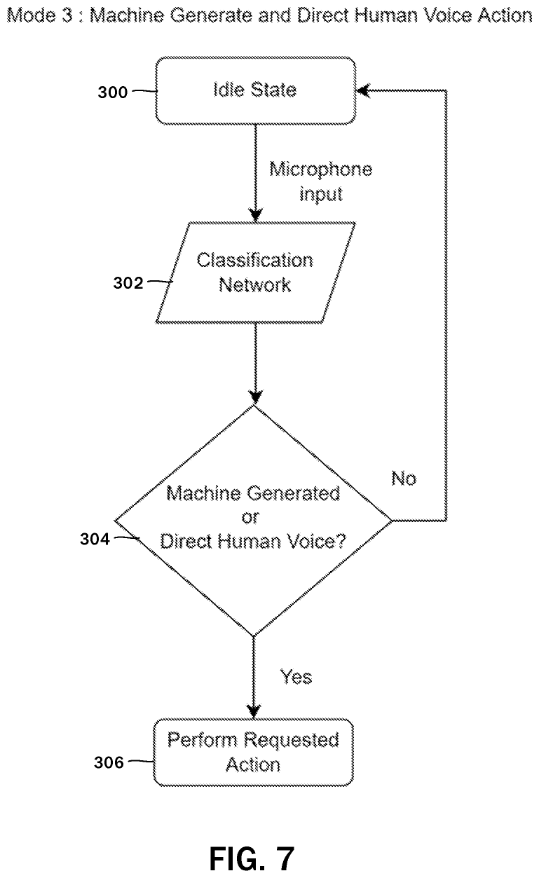

The flowchart of FIG. 7 illustrates a third mode of operation, referred to as machine generated or direct human voice action. Again, the virtual assistant-enabled device 10 initially begins in an idle state 300, and when the microphone 26 receives an input audio 14, the process moves to the classifier 42 in a step 302. If, per decision block 304 it is determined that the audio 14 is machine-generated or human-generated, the process moves to a step 306 of performing the requested action. If it is neither or indeterminate, the process returns to the idle state 300.

Referring again to the block diagram of FIG. 3, the virtual assistant-enabled device 10 may be configured to operate in any of the foregoing modes, and changing between the modes may be achieved via a user interface 48. In some implementations, the virtual assistant-enabled device 10 may include a graphical input device to select the operating mode. Alternatively, the user interface 48 may establish a connection with an external device that is loaded with a configuration application that allows the user to select the operating mode. Once set, the configuration information of the operating mode may be transmitted and committed to the virtual assistant-enabled device 10.

The particulars shown herein are by way of example and for purposes of illustrative discussion of the embodiments of a pattern recognition system with user-definable patterns on edge devices utilizing a hybrid remote and local processing approach, and are presented in the cause of providing what is believed to be the most useful and readily understood description of the principles and conceptual aspects. In this regard, no attempt is made to show details with more particularity than is necessary, the description taken with the drawings making apparent to those skilled in the art how the several forms of the present disclosure may be embodied in practice.

What is claimed is:

1. A method for discriminating between direct and machine-generated human voices, the method comprising:
capturing on a microphone a directly-generated voice audio sample from a human utterance;
capturing on the microphone a machine-generated voice audio sample outputted by a loudspeaker from a pre-recording of another human utterance;
extracting, with a machine learning feature extractor, discriminative features between the directly-generated voice audio sample and the machine-generated voice audio sample; and
selectively generating a response to a command in the captured directly-generated voice audio sample or the captured machine-generated voice audio sample.

2. The method of claim 1, wherein the machine learning feature extractor is selected from a group consisting of: a multilayer perceptron (MCP), a convolutional neural network (CNN), and a recurrent neural network (RNN).

3. The method of claim 1, further comprising:
training the machine learning feature extractor with an audio sample classifier using a first class of voice data from audio captured directly from a human and a second class of voice data from audio captured from the loudspeaker.

4. The method of claim 3, wherein training the machine learning feature extractor includes adding one or more types of noise signals to either or both the audio captured directly from a human and audio captures from the loudspeaker to enhance the machine learning feature extractor to operate over diverse environmental conditions.

5. The method of claim 1, wherein one of the discriminative features of the machine-generated voice audio sample is a non-flat frequency response in an audible frequency band.

6. The method of claim 1, wherein one of the discriminative features of the machine-generated voice audio sample is a ringing.

7. The method of claim 1, wherein one of the discriminative features of the machine-generated voice audio sample is a vibration.

8. The method of claim 1, wherein one of the discriminative features of the machine-generated voice audio sample is distortion.

9. The method of claim 1, wherein on of the discriminative features of the machine-generated voice audio sample is added noise.

10. The method of claim 3, wherein the machine learning feature extractor is trained using voice data from audio captured from a plurality of different loudspeakers, each having a unique set of sound reproduction characteristics.

11. A system for discriminating between direct and machine-generated human voices, the system comprising:
a microphone capturing both directly-generated voice audio samples from a human utterance and a machine-generated voice audio samples outputted by a loudspeaker from a pre-recording of the human utterance; and
a machine learning classifier receptive to the directly-generated voice audio samples and the machine-generated voice audio samples, the machine learning classifier deriving discriminative features between the directly-generated voice audio samples and the machine-generated voice audio samples and classifying as either directly generated or machine generated.

12. The system of claim 11, wherein the machine learning classifier is selected from a group consisting of: a multilayer perceptron (MCP), a convolutional neural network (CNN), and a recurrent neural network (RNN).

13. The system of claim 11, further comprising:
a wake word detection module cooperating with the machine learning classifier.

14. A system for discriminating between direct and machine-generated human voices, the system comprising:
a microphone capturing both directly-generated voice audio samples from a human utterance and a machine-generated voice audio samples outputted by a loudspeaker from a pre-recording of the human utterance as input audio samples;
a machine learning classifier receptive to the input audio samples, the machine learning classifier deriving discriminative features between the directly-generated voice audio samples and the machine-generated voice audio samples and identifying the input audio samples as either directly generated or machine generated based upon the derived discriminative features;
a command processor connected to the machine learning classifier, the command processor selectively generating responses to commands in the input audio samples depending upon an activated one of operating modes.

15. The system of claim 14, wherein one of the operating modes is a direct voice action mode in which the command processor generates a response to the command when the input audio sample is identified as a directly generated.

16. The system of claim 14, wherein one of the operating modes is a machine generated voice action mode in which the command processor generates a response to the command when the input audio sample is identified as machine generated.

17. The system of claim 14, wherein one of the operating modes is a hybrid action mode in which the command processor generates a response to the command when the input audio sample is identified as either directly generated or machine generated.

18. The system of claim 14, further comprising:
a user interface for selecting and configuring the operating modes.

19. The system of claim 14, further comprising:
an audio sample classifier training the machine learning classifier using a first class of voice data corresponding to directly-generated voice audio samples and a second class of voice data corresponding to machine0generated voice audio samples.

20. The system of claim 14, wherein the machine learning classifier is selected from a group consisting of: a multilayer perceptron (MCP), a convolutional neural network (CNN), and a recurrent neural network (RNN).
